(19) United States
(12) Patent Application Publication
(10) Pub. No.: US 2026/0361553 A1
(43) Pub. Date: Nov. 12, 2026

(54) PHYSICALLY UNCLONABLE FUNCTION DEVICE AND METHOD FOR FABRICATING THE SAME

(71) Applicant: United Microelectronics Corp., Hsinchu (TW)

(72) Inventors: Chang-Yih CHEN, Tainan City (TW); Hung-Chan LIN, Tainan City (TW); Kuo-Hsing LEE, Hsinchu County (TW); Chun-Hsien LIN, Tainan City (TW); Yi-Wen CHEN, Chiayi County (TW); Chia-Chen SUN, Kaohsiung City (TW); Kun-Szu TSENG, Tainan City (TW)

(21) Appl. No.: 18/599,274

(22) Filed: Mar. 8, 2024

(30) Foreign Application Priority Data
Jan. 29, 2024 (CN) 202410123306.X

(51) Int. Cl. H04L 9/32; G11C 5/06; H10B 61/00

(52) U.S. Cl. CPC H04L 9/3278; G11C 5/063; H10B 61/10; H04L 2209/122

(57) ABSTRACT

A physically unclonable function device includes N PUF units and an operating circuit. Each of the PUF units is essentially consisting of a transistor, a first MTJ structure component (hereinafter referred to as the MTJ structure component) and a second MTJ structure component. The first MTJ structure component and the second MTJ structure component are connected in parallel to the drain of the transistor; and at least one of the first MTJ structure component and the second MTJ structure component has a magnetic tunneling oxide layer with a broken-down state. The operating circuit is electrically connected to the N PUF units, and is used to read a set of conduction states in the N PUF units using at least one reading sequence, and output a set of state values according to the set of conduction states. Wherein, N is a positive integer greater than two.

This application claims the benefit of China Application Serial No. 202410123306.X filed at Jan. 29, 2024, the subject matter of which is incorporated herein by reference.

### BACKGROUND

### Technical Field

The disclosure relates to a semiconductor device and the method for fabricating the same, and more particularly to a physically unclonable function device and the method for fabricating the same.

### Description of Background

With the increasing popularity of Internet of Things (IOT) technology, different Internet devices (such as mobile communication devices, sensors installed on the devices, and their built-in software) can communicate with each other through the Internet, by which more and more data can be stored and shared in digital form, while providing the convenience of information integration. However, it also brings higher information security risks. Therefore, the security of the internet devices and the networks connecting there between is becoming more and more important.

Traditional IoT encryption technology is to use an encryption mathematical model (algorithm) to encode the information or data to be protected into ciphertext, and store the cryptographic key, digital string or password established by the algorithm in a hardware apparatus. After receiving the ciphertext, the hardware apparatus decodes the data back into plaintext based on the stored cryptographic key, digital string, or algorithm. Unauthorized persons cannot guess the correct cryptographic key, nor can easily calculate or crack the correct string or password for the cryptographic key by using a computer to try possible combinations thereof.

However, the traditional encryption technology still has the risks that the user identities may be stolen, tampered with, and the password of the cryptographic key may be lost. Moreover, since the password is stored in the hardware apparatus, each multiply accumulate operation of the cryptographic key requires frequent and repeated access to the password from the memory of the hardware apparatus, which requires a large and additional operating cost (consumption of power and time).

Therefore, there is a need of providing a physically unclonable function device and the method for fabricating the same to obviate the drawbacks encountered from the prior art.

### SUMMARY

One aspect of the present disclosure is to provide a physically unclonable function device includes N physically unclonable function units (hereinafter referred to as PUF units) and an operating circuit. Each of the PUF units is essentially consisting of a transistor, a first magnetic tunneling junction (MTJ) structure component (hereinafter referred to as the MTJ structure component) and a second MTJ structure component. The first MTJ structure component and the second MTJ structure component are connected in parallel to the drain of the transistor; and at least one of the first MTJ structure component and the second MTJ structure component has a magnetic tunneling oxide layer with a broken-down state. The operating circuit is electrically connected to the N PUF units, and is used to read a set of conduction states in the N PUF units using at least one reading sequence, and output a set of state values according to the set of conduction states. Wherein N is a positive integer greater than two.

Another aspect of the present disclosure is to provide a method for fabricating a physically unclonable function device, wherein the method includes steps as follows: First, N PUF units are formed, and each of the N PUF units is essentially consisting of a transistor, a first MTJ structure component and a second MTJ structure component, where the first MTJ structure component and the second MTJ structure component are connected in parallel to the drain of the transistor. An operating circuit electrically connected to the N PUF units is then formed. Subsequently, a programming voltage is applied to the N PUF units through an operating the circuit, so that at least one of the first MTJ structure component and the second MTJ structure component has a magnetic tunneling oxide layer with a broken-down state. Wherein N is a positive integer greater than two.

In accordance with the aforementioned embodiments of the present disclosure, a physically unclonable function device and the method for fabricating the same are provided. The physically unclonable function device includes N PUF units and an operating circuit, where N is a positive integer greater than two. Each of the N PUF units is essentially consisting of a transistor and two MTJ structure components connected in parallel to the drain of the transistor. Physical properties or process variation characteristics that cannot be predicted, controlled, and replicated are provided in the magnetic tunneling oxide layer of at least one of the two MTJ structure components by applying the random variables occurs during the semiconductor manufacturing process serving as a unique identification code to verify the identity of the physically unclonable function device. Such that it can provide more kinds of identity identification code combinations than the traditional IoT encryption technology.

When a hardware apparatus with a built-in physically unclonable function device receives the external ciphertext encrypted with this identification code, a verification can be perform immediately based on the identification code, and then the external ciphertext can be decoded and back-translated into plain text. This can prevent the loss of the cryptographic key, and prevent the user's identity and digital data from being stolen or tampered with, thereby reducing the risks of system security.

Because the identification code provided by the physically unclonable function device is a native cryptographic key generated directly in the hardware apparatus and introducing random variables through the process for manufacturing the hardware. In addition, both the decrypted entropy source and the native cryptographic key can be prepared within micro-see, without the support of additional software. Such that the need for additional operation cost (such as the power consumption and accessing time) required by the traditional IoT encryption technology to frequent and repeated access the cryptographic key stored in the hardware apparatus can be omitted. In addition, it is also relatively easy to design the physically unclonable function device into a chip.

### BRIEF DESCRIPTION OF THE DRAWINGS

The above objects and advantages of the present disclosure will become more readily apparent to those ordinarily skilled in the art after reviewing the following detailed description and accompanying drawings, in which:

FIG. 1A is a diagram illustrating the configuration of a physically unclonable function device, according to one embodiment of the present disclosure;

FIG. 1B is a cross-sectional view illustrating a MTJ structure component of the physically unclonable function device as depicted in FIG. 1A;

FIG. 2 is a diagram illustrating the configuration of another physically unclonable function device, according to another embodiment of the present disclosure;

FIG. 3 is a diagram illustrating a binary matrix composed of a plurality of physically unclonable function devices, according to one embodiment of the present disclosure; and

FIG. 4 is a diagram illustrating a ternary matrix composed of a plurality of physically unclonable function devices, according to another embodiment of the present disclosure.

### DETAILED DESCRIPTION

The embodiments as illustrated below provide a physically unclonable function device and the method for fabricating the same, which can prevent the loss of the cryptographic key, and prevent the user's identity and digital data from being stolen or tampered with. Such that the need for additional operation cost (such as the power consumption and accessing time) required by the traditional IoT encryption technology to frequent and repeated access the cryptographic key stored in the hardware apparatus can be omitted. The present disclosure will now be described more specifically with reference to the following embodiments illustrating the structure, method and arrangements thereof.

It is to be noted that the following descriptions of preferred embodiments of this disclosure are presented herein for purpose of illustration and description only. It is not intended to be exhaustive or to be limited to the precise form disclosed. Also, it is important to point out that there may be other features, elements, steps, and parameters for implementing the embodiments of the present disclosure which are not specifically illustrated. Thus, the descriptions and the drawings are to be regard as an illustrative sense rather than a restrictive sense. Various modifications and similar arrangements may be provided by the persons skilled in the art within the spirit and scope of the present disclosure. In addition, the illustrations may not be necessarily drawn to scale, and the identical elements of the embodiments are designated with the same reference numerals.

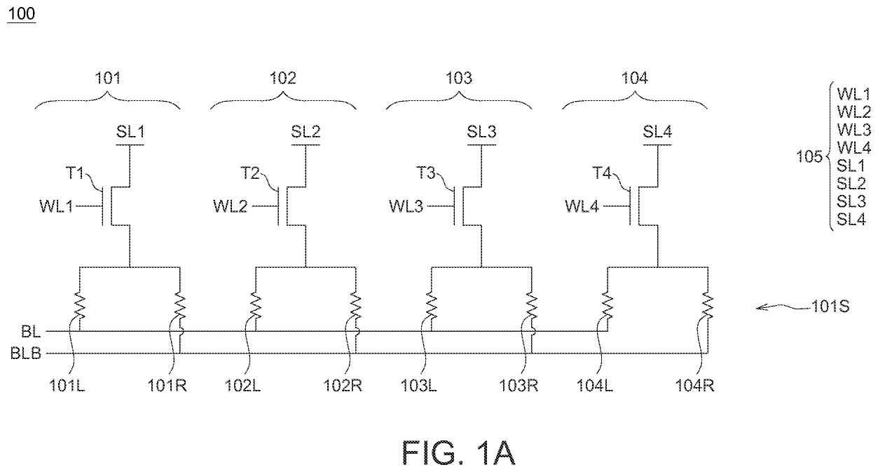

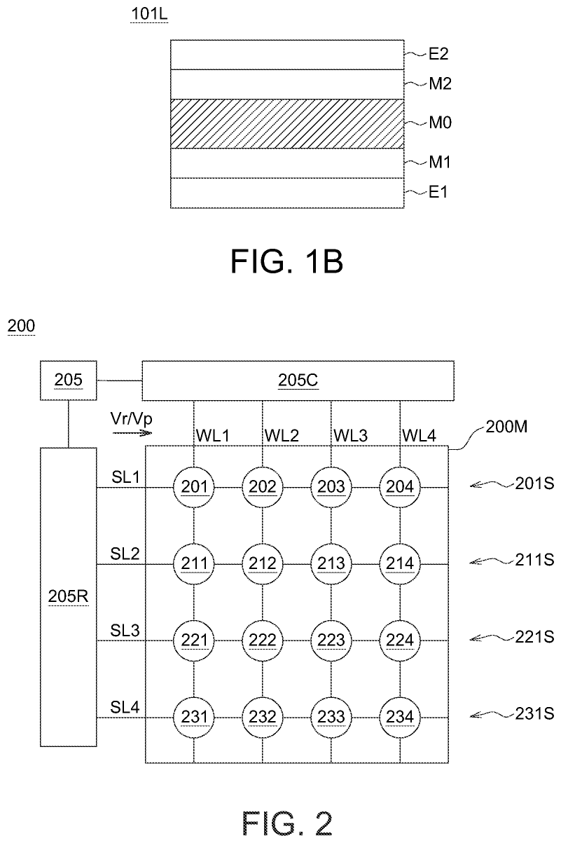

FIG. 1A is a diagram illustrating the configuration of a physically unclonable function device 100, according to one embodiment of the present disclosure. In some embodiments of the present disclosure, the physically unclonable function device 100 includes includes N PUF units (such as, four PUF units 101-104) and an operating circuit 105. Wherein N is a positive integer greater than two.

In the present embodiment, the physically unclonable function device 100 may include a PUF unit string 101S composed of four PUF units 101-104 (but is not limited to this regard). The operating circuit 105 is electrically connected to each of the PUF units 101-104 respectively through a bit line BL, a bit-line-bar BLB, a plurality of word lines WL1-WL4 and a plurality of source lines SL1-SL4.

Wherein, each of the PUF units (for example, one of the PUF units 101-104) is a magnetoresistive random access memory (MRAM) unit essentially consisting of a transistor (for example, one of the transistors T1-T4), a first MTJ structure component (for example, one of the first MTJ structure components 101R-104R) and a second MTJ structure component (for example, one of the second MTJ structure components 101L-104L). But the structure of the PUF unit is not limited to this regard, for example, each of the PUF units may include more active/passive components.

FIG. 1B is a cross-sectional view illustrating a MTJ structure component (for example, the first MTJ structure components 101R) of the physically unclonable function device 100 as depicted in FIG. 1A. In the present embodiment, the MTJ structure component in each of the PUF units (such as, the first MTJ structure components 101L of the PUF unit 103) of the physically unclonable function device 100 includes a lower electrode layer E1, a first magnetic layer M1, a magnetic tunneling oxide layer MO, a second magnetic layer M2 and an upper electrode layer E2 stacked in sequence, and the three together form a vertical MTJ structure.

In some embodiments of the present disclosure, the material constituting the first magnetic layer M1 and the second magnetic layer M2 may include an iron-containing magnetic material, such as cobalt iron boron (CoFeB). The material constituting the magnetic tunneling oxide layer MO may include one of magnesium oxide (MgO), amorphous aluminum oxide (AlOx), amorphous gallium oxide (HfOx), or any of the arbitrary combinations thereof. The conductive material constituting the upper electrode layer E2 may include (but is not limited to) ruthenium, tantalum, platinum, copper (Cu), gold (Au), aluminum (Al) or any of the arbitrary combinations thereof. The material constituting the lower electrode layer E1 may include one of tantalum (Ta), tungsten (W), platinum (pt), cobalt (Co), ruthenium (Ru), or any of the arbitrary combinations thereof.

In the present embodiment, the first magnetic layer M1 and the second magnetic layer M2 are both cobalt iron boron layers. The material constituting the magnetic tunneling oxide layer MO preferably includes magnesium oxide. The upper electrode layer E2 may be a stacked layer composed of Ta metal and Ru metal. The lower electrode layer E1 may be a W metal layer. And there is perpendicular magnetic anisotropy (PMA) between the first magnetic layer M1 and the second magnetic layer M2. The second magnetic layer M2 includes a ferromagnetic material (also called a pinned ferromagnetic layer) whose magnetic orientation has been fixed or pinned and is not easily affected and reversed by the influence of an external magnetic field. The first magnetic layer M1 includes ferromagnetic material that is not fixed or pinned in a specific magnetic orientation, and its magnetic direction can be rotated during the subsequent programming process (also called a free ferromagnetic layer).

When the operating circuit 105 applies a read voltage Vr through the bit line BL, the bit-line-bar BLB, the word line WL1 and the source line SL1 to turn on the transistor T1 to read the magnetic orientations of both the first magnetic layer M1 and second magnetic layer M2, and the magnetization orientations of the first magnetic layer M1 and the second magnetic layer M2 are in parallel directions (parallel to the direction that is perpendicular to the MTJ of these two), the vertical resistance between them is very small. Alternatively, when magnetization orientations of the first magnetic layer M1 and second magnetic layer M2 are in the anti-parallel direction AP (anti-parallel to the direction that is perpendicular to the MTJ of these two), the vertical resistance between them is very large.

Please refer to FIG. 1A again, one end of each word line (e.g., each one of the word lines WL1-WL4) is electrically connected to the operating circuit 105, and the other end is electrically connected to the gate of the corresponding transistor (e.g., the corresponding one of transistors T1-T4) in the corresponding PUF unit (e.g., the corresponding one of the PUF units 101-104). Each source line (e.g., each one of the source lines SL1-SL4) is electrically connected to the source of a corresponding transistor (e.g., the corresponding one of the transistors T1-T4) in the corresponding PUF unit (e.g., the corresponding one of the PUF units 101-104). The bit line BL is electrically connected to the second MTJ structure components 101L-104L in each of the PUF units 101-104. The bit-line-bar BLB is electrically connected to the first MTJ structure components 101R-104R in each of the PUF units 101-104.

Taking the PUF unit 101 as an example, one end (e.g., the upper electrode layer E2) of the first MTJ structure component 101R is electrically connected to the drain of the transistor T1, and the other end (e.g., the lower electrode layer E1) of the first MTJ structure component 101R is electrically connected to the bit-line-bar BLB. One end (e.g., the upper electrode layer E2) of the second MTJ structure component 101L is electrically connected to the drain of the transistor T1, and the other end (e.g., the lower electrode layer E1) of the second MTJ structure component 101L is electrically connected to the bit line BL. And the first MTJ structure component 101R and the second MTJ structure component 101L are electrically connected to the drain of the transistor T1 in parallel with each other.

Although the above-mentioned physically unclonable function device 100 is manufactured by existing semiconductor process technology, but random variables can be introduced during the manufacturing process, by adjusting parameters, such as deposition temperature, thermal budget, type of reaction gas, flow rate, etc., so as to create obvious material or structural differences between the magnetic tunneling oxide layers MO of the first MTJ structure components 101R-104R and the second MTJ structure components 101L-104L in each one of the PUF units 101-104 of the physically unclonable function device 100.

When the operating circuit 105 applies a high level of programming voltage Vp to each of the PUF units 101-104, the magnetic tunneling oxide layer MO of at least one of the first MTJ structure component 101R and the second MTJ structure component 101L (in each of the PUF units, hereinafter to take the PUF unit 101 as an example) may be broken-down because it cannot withstand the high voltage.

For example, in the present embodiment, the step of applying the programming voltage Vp includes steps as follows: Firstly, a turn-on voltage is applied to the gates of the transistors T1-T4 in the PUF units 101-104 through the source lines WL1-WL4, so to cause a high voltage difference between each of the source lines SL1-SL4 and the drain of the corresponding one the transistors T1-T4. This causes the magnetic tunnel oxide layer MO of at least one of the first MTJ structure components 101R-104R and the second MTJ structure components 101L-104L (hereinafter, to take the first MTJ structure component 101R as an example) broken-down (with a broken-down state). As a result, the first MTJ structure component 101R with the magnetic tunneling oxide layer MO with the broken-down state is permanently electrically conductive. Therefore, whether the magnetization orientation of the first MTJ structure component 101R programed is in parallel direction or anti-parallel direction, its vertical resistance is close to 0. In other words, the first MTJ structure component 101R with the broken-down magnetic tunnel oxide layer MO can be regarded as a failed component.

Subsequently, when a reading voltage Vr is applied by the operating circuit 105 to turn on the transistors T1-T4 through the bit line BL, the inverted bit line BLB, the word lines WL1-WL4 and the source lines SL1-SL4 to read the magnetization orientation (and vertical resistance) of the first MTJ structure components 101R-104R and the second MTJ structure components 101L-104L of the PUF units 101-104, a set of state values can be obtained according to the turn-on sequence of the transistors T1-T4 and the conduction states of the first MTJ structure components 101R-104R and the second MTJ structure components 101L-104L, which can be output to serve as the only code to verify the identity of the physically unclonable function device 100.

In some embodiments of the present disclosure, the level and/or the pulse time of the programming voltage Vp applied to each of the PUF units 101-104 can be controlled by the operating circuit 105, so as to make only one MTJ structure component among the first MTJ structure components 101R-104R and the second MTJ structure components 101L-104L (in each one of the PUF units 101-104) failed due to the broken-down state of the magnetic tunneling oxide layer MO. For example, in the present embodiment, there is only one MTJ structure component (such as the first MTJ structure components 101R and 102R) failed in the PUF units 101 and 102 respectively; and there is only one MTJ structure component (such as the second MTJ structure components 103L and 104L) failed in the PUF units 103 and 104 respectively.

Both of the PUF units 101 and 102 respectively having one MTJ structure component (the first MTJ structural components 101R and 102R) with the failed state (expressed as R: x) and one MTJ structure component (the second MTJ structure components 101L and 102L) with the normal state (expressed as L: O) are given a state value of 1 (R: x/L: O=1). Both of the PUF units 103 and 104 respectively having one MTJ structure component (the second MTJ structure components 103L and 104L) with the failed state (expressed as L: x) and one MTJ structure component (the first MTJ structural components 103R and 104R) with the normal state (expressed as R: O) are given a state value of 0 (R: O/L: x=0). Then, according to the forward reading sequence of the PUF units 101-104, a set of state values of 1, 1, 0, 0 expressing the states of the PUF unit string 101S of the physically unclonable function device 100 can obtain, as listed in Table 1:

TABLE 1

| PUF units | 101 | 102 | 103 | 104 |
|---|---|---|---|---|
| State: | R: x | R: x | R: ∘ | R: ∘ |
| | L: ∘ | L: ∘ | L: x | L: x |
| Set of the state values of the | 1 | 1 | 0 | 0 |
| PUF units string | | | | |

Since each of state values obtained for respectively expressing the states of the PUF units 101-104 is a binary code of 0 or 1, thus each set of state values has 2^{N} arrangements of binary numerical sequences. In the present embodiment, the physically unclonable function device 100 has four PUF units 101-104 (that is, N=4), and each set of state values has 16 (2⁴) arrangements of binary numerical sequences. If further taking account the variations in the reading order of the four PUF units 101-104, since there are 24 (4!=4×3×2×1) reading orders, thus the physically unclonable function device 100 can provide 384 (16×24) arrangements of binary numerical sequences (the duplicate binary numerical sequences are not excluded) to serve as unique identification codes for verifying the identity of the physically unclonable function device 100.

In addition, in some other embodiments of the present disclosure, the level and/or the pulse time of the programing voltage Vp applied to each of the PUF units 101-104 can be controlled by the operating circuit 105, so as either to make at least one of the first MTJ structure components 101R-104R and the second MTJ structure components 101L-104L (respectively in each of the PUF units 101-104) failed, or to make both of them all failed, due to the broken-down state of the magnetic tunneling oxide layer MO disposed therein.

For example, in one embodiment, by adjusting the level and/or the pulse time of the programing voltage Vp, it can be controlled that only the first MTJ structure component 101R disposed in the PUF unit 101 is failed; that the first MTJ structure component 102R and the second MTJ structure component 102L both disposed in the PUF unit 102 are failed; or that only the second MTJ structure components 103L and 104L respectively disposed in the PUF units 103 and 104 are failed.

The PUF unit 101 having the first MTJ structural components 101R with the failed state (expressed as R: x) and the second MTJ structure components 101L with the normal state (expressed as L: O) is given a state value of 1 (R: x/L: O=1). The PUF unit 102 having the first MTJ structural components 102R with the failed state (expressed as R: x) and the second MTJ structure components 102L with the failed state (expressed as L: x) is given a state value of X (R: x/L: x=X). Both of the PUF units 103 and 104 respectively having one MTJ structure component (the second MTJ structure components 103L and 104L) with the failed state (expressed as L: x) and one MTJ structure component (the first MTJ structural components 103R and 104R) with the normal state (expressed as R: O) are given a state value of 0 (R: O/L: x=0). Then, according to the forward reading sequence of the PUF units 101-104, a set of state values of 1, X, 0, 0 expressing the states of the PUF unit string 101S of the physically unclonable function device 100 can be obtained, as listed in Table 2:

TABLE 2

| PUF units | 101 | 102 | 103 | 104 |
|---|---|---|---|---|
| State: | R: x | R: x | R: ∘ | R: ∘ |
| | L: ∘ | L: ∘ | L: x | L: x |
| Set of the state values of the | 1 | X | 0 | 0 |
| PUF units string | | | | |

Since each of state values obtained for respectively expressing the states of the PUF units 101-104 is a trinary code of 0, X or 1, thus each set of state values has 3^{N} arrangements of binary numerical sequences. In the present embodiment, the physically unclonable function device 100 has four PUF units 101-104 (that is, N=4), and each set of state values has 81 (3⁴) arrangements of binary numerical sequences. If further taking account the variations in the reading order of the four PUF units 101-104, since there are 24 (4!=4×3×2×1) reading orders, thus the physically unclonable function device 100 can provide 1,944 (81×24) arrangements of binary numerical sequences (the duplicate binary numerical sequences are not excluded) to serve as unique identification codes for verifying the identity of the physically unclonable function device 100.

In comparison with a traditional physically unclonable function device simply constituted by 8 MRAMs each of which provides a binary code of 0 or 1, there are merely 256 (2⁸) arrangements of binary numerical sequences is provided to serve as identification codes. The physically unclonable function devices 100 described in the embodiments of the present disclosure can obviously provide more (384 or 1,944) identification codes.

Of note that, the physical structure of the physically unclonable function devices 200 is not limited to that merely having a single PUF unit string 101S. FIG. 2 is a diagram illustrating the configuration of another physically unclonable function device 200, according to another embodiment of the present disclosure. In the present embodiment, the physically unclonable function devices 200 may be a MRAMs array (matrix) structure 200M including a plurality of PUF unit strings (e.g., four PUF unit strings 201S, 211S, 221S and 231S).

Wherein, each of the PUF unit strings 201S, 211S, 221S and 231S includes four PUF units 201-204, 211-214, 221-224, and 231-234. The operating circuit 205 of the physically unclonable function device 200 further includes a column decoder 205R and a row decoder 2050. The row decoder 205C is electrically connected to the PUF unit strings 201S, 211S, 221S and 231S respectively through the word lines WL1-WL4. The column decoder 205R is respectively connected to the PUF unit strings 201S, 211S, 221S and 231S through the bit lines BL1-BL4. Since the structure and connection of each of the PUF unit strings 201S, 211S, 221S, and 231S are similar to that of the PUF unit string 101S, no further description is redundantly given.

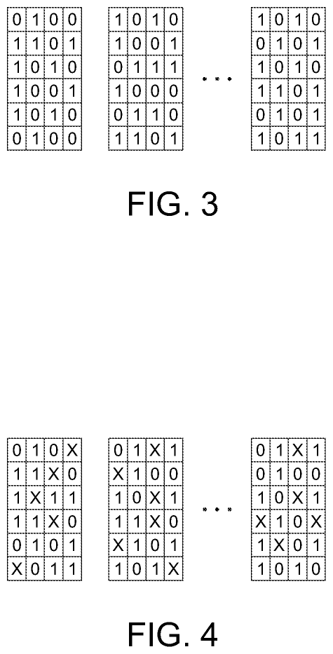

In some embodiments of the present disclosure, the level and/or the pulse time of the programing voltage Vp applied to each of the PUF units 201-204, 211-214, 221-224, and 231-234 can be controlled by the operating circuit 205, so as to make only one MTJ structure component among the first MTJ structure components and the second MTJ structure components (in each one of the PUF units 201-204, 211-214, 221-224 and 231-234) failed due to the broken-down state of the magnetic tunneling oxide layer MO. Such that, each of state values obtained for respectively expressing the states of the PUF units 201-204, 211-214, 221-224, and 231-234 is a binary code of 0 or 1. In other words, the physically unclonable function device 200 can provide a 4×4 binary code array (matrix) diagram (as shown in FIG. 3) with 2¹⁶ arrangements of binary numerical sequences (the duplicate binary numerical sequences are not excluded) to serve as unique identification codes for verifying the identity of the physically unclonable function device 200.

In another embodiment of the present disclosure, the level and/or the pulse time of the programing voltage Vp applied to each of the PUF units 201-204, 211-214, 221-224 and 231-234 can be controlled by the operating circuit 205, so as either to make at least one of the first MTJ structure component and the second MTJ structure component (in each of the PUF units 201-204, 211-214, 221-224 and 231-234) failed, or to make both of them all failed, due to the broken-down state of the magnetic tunneling oxide layer MO disposed therein. Such that, each of state values obtained for respectively expressing the states of the PUF units 201-204, 211-214, 221-224, and 231-234 is a trinary code of 0, X or 1.

In other words, the physically unclonable function device 200 can provide a 4×4 binary code array (matrix) diagram (as shown in FIG. 4) with 316 arrangements of binary numerical sequences (the duplicate trinary numerical sequences are not excluded) to serve as unique identification codes for verifying the identity of the physically unclonable function device 200. In comparison with a traditional physically unclonable function device simply constituted by 8 MRAMs and the physically unclonable function device 100 aforementioned, the physically unclonable function devices 200 described in the present embodiment can obviously provide more identification codes.

When a hardware apparatus (not shown) with a built-in physically unclonable function device 100 or 200 receives the external ciphertext encrypted with the identification codes, a verification can be perform immediately based on the identification codes, and then the external ciphertext can be decoded and back-translated into plain text. This can prevent the loss of the cryptographic key, and prevent the user's identity and digital data from being stolen or tampered with, thereby reducing the risks of system security.

If the matrix size (the number of the PUF unit string) of the physically unclonable function devices 100 and 200 is increased, more diverse identification codes, more complex challenge-response pairs (CRPs) and more random number combinations can be provided, so as to improve the unpredictability of native cryptographic key generated directly in the hardware apparatus and deter hackers from destroying the trustworthy foundation, thereby providing better resistance to hacker attacks and the ability to prevent password cracking.

In addition, as mentioned above, the physically unclonable function devices 100 and 200 described in the embodiments of the present disclosure can provide more identification codes and higher information security density and level. In other words, the size of the physically unclonable function devices 100 and 200 can be miniaturized by reducing the number of PUF units in the physically unclonable function devices 100 and 200, while can provide the same information security level as that of the traditional ones. Such that, it is relatively easier to design circuits containing the physically unclonable function devices 100 and 200 into a chip.

Because the identification codes provided by the physically unclonable function devices 100 and 200 are native cryptographic keys generated directly in the hardware apparatus and introducing random variables through the process for manufacturing the hardware. In addition, both the decrypted entropy source and the native cryptographic keys can be prepared within micro-sec, without the support of additional software. Such that the need for additional operation cost (such as the power consumption and accessing time) required by the traditional IoT encryption technology to frequent and repeated access the cryptographic key stored in the hardware apparatus can be omitted. In addition, it is also relatively easy to design the physically unclonable function device into a chip.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A physically unclonable function device, comprising:
N physically unclonable function units (PUF units), wherein each of the PUF units is essentially consisting of a transistor, a first magnetic tunneling junction (MTJ) structure component and a second MTJ structure component; wherein both the first MTJ structure component and the second MTJ structure component are connected in parallel to the drain of the transistor; and at least one of the first MTJ structure component and the second MTJ structure component has a magnetic tunneling oxide layer with a broken-down state; and
an operating circuit, electrically connected to the N PUF units, and used to read a set of conduction states in the N PUF units using at least one reading sequence, and to output a set of state values according to the set of conduction states;
wherein N is a positive integer greater than two.

2. The physically unclonable function device according to claim 1, wherein each one of the first MTJ structure component and the second MTJ structure component comprises a pinned ferromagnetic layer, a free ferromagnetic layer and the magnetic tunneling oxide layer disposed between the pinned ferromagnetic layer and the free ferromagnetic layer.

3. The physically unclonable function device according to claim 2, wherein the pinned ferromagnetic layer and the free ferromagnetic layer comprise cobalt iron boron (CoFeB), and the magnetic tunneling oxide layer comprises magnesium oxide (MgO).

4. The physically unclonable function device according to claim 1, wherein only the first MTJ structure component has the magnetic tunneling oxide layer with the broken-down state.

5. The physically unclonable function device according to claim 1, wherein both the first MTJ structure component and the second MTJ structure component have the magnetic tunneling oxide layer with the broken-down state.

6. The physically unclonable function device according to claim 1, wherein the N PUF units are included in a unit array (matrix) structure.

7. The physically unclonable function device according to claim 1, wherein the N PUF units form a unit array (matrix) structure, and the operating circuit comprises a column decoder and a row decoder.

8. The physically unclonable function device according to claim 7, wherein the operating circuit further comprises:
a word line (WL), having one end electrically connected to the row decoder and another end electrically connected to a gate of the transistor in each of the N PUF units;
a bit line (BL), having one end electrically connected to the column decoder and another end electrically connected to the first MTJ structure component in each of the N PUF units;
a bit-line-bar (BLB), having one end electrically connected to the row decoder and another end electrically connected to the second MTJ structure component in each of the N PUF units; and
a source line, having one end electrically connected to a power source and another end electrically connected to a source of the transistor in each of the N PUF units.

9. The physically unclonable function device according to claim 1, wherein only one of the first MTJ structure component and the second MTJ structure component in each of the N PUF units has the magnetic tunneling oxide layer with the broken-down state; so as to make the set of state values has 2^{N} arrangements.

10. The physically unclonable function device according to claim 9, wherein each of the 2^{N} arrangements is a binary numerical sequence or a binary code array (matrix) diagram.

11. The physically unclonable function device according to claim 1, wherein any one of the first MTJ structure component and the second MTJ structure component or both of them in each of the N PUF units has the magnetic tunneling oxide layer with the broken-down state, so as to make the set of state values has 3^{N} arrangements.

12. The physically unclonable function device according to claim 11, wherein each of the 3^{N} arrangements is a trinary numerical sequence or a trinary code array (matrix) diagram.

13. A method for fabricating a physically unclonable function device, comprising:
forming N physically unclonable function units (PUF units) to make each of the PUF units essentially consisting of a transistor, a first MTJ structure component and a second MTJ structure component; wherein both the first MTJ structure component and the second MTJ structure component are connected in parallel to the drain of the transistor; and at least one of the first MTJ structure component and the second MTJ structure component has a magnetic tunneling oxide layer with a broken-down state; and
forming an operating circuit electrically connected to the N PUF units; and
applying a programing voltage to the N PUF units through the operating the circuit, so that at least one of the first MTJ structure component and the second MTJ structure component has a magnetic tunneling oxide layer with a broken-down state;
wherein N is a positive integer greater than two.

14. The method according to claim 11, wherein the operating circuit further comprises:
a word line (WL), having one end electrically connected to the row decoder and another end electrically connected to a gate of the transistor in each of the N PUF units;
a bit line (BL), having one end electrically connected to the column decoder and another end electrically connected to the first MTJ structure component in each of the N PUF units;
a bit-line-bar (BLB), having one end electrically connected to the row decoder and another end electrically connected to the second MTJ structure component in each of the N PUF units; and
a source line, having one end electrically connected to a power source and another end electrically connected to a source of the transistor in each of the N PUF units.

15. The method according to claim 14, wherein applying the programing voltage to the N PUF units comprises:
applying a turn-on voltage to the gate of the transistor in each of the N PUF units through the word line; and
applying a high voltage though the source line to make the at least one of the first MTJ structure component and the second MTJ structure component having a magnetic tunneling oxide layer with the broken-down state.
